(19) United States
(12) Patent Application Publication
(10) Pub. No.: US 2009/0083580 A1
(43) Pub. Date: Mar. 26, 2009

(54) Techniques for Background Testing a Hard Disk Drive

(76) Inventors: Robert B. Postage, Hillsborough, NC (US); Donald R. Frame, Apex, NC (US); Pamela A. Morse, Durham, NC (US); Stanley H. Osgood, Hillsborough, NC (US)

Correspondence Address: DILLON & YUDELL LLP, 8911 N. CAPITAL OF TEXAS HWY, SUITE 2110, AUSTIN, TX, 78759, US

(21) Appl. No.: 11/858,665

(22) Filed: Sep. 20, 2007

(51) Int. Cl. G06F 11/267

(52) U.S. Cl. 714/34; 714/E11.165

(57) ABSTRACT

A technique for background testing a hard disk drive, when an associated system is powered and the hard disk drive is available, includes receiving an interrupt test indication that indicates that the background testing of the hard disk drive is to be interrupted. The technique also includes discontinuing, at a current test location, the background testing of the hard disk drive in response to the interrupt test indication. Finally, current test results are saved in response to the interrupt test indication.

### BACKGROUND

1. Field

This disclosure relates generally to a hard disk drive and, more specifically to techniques for background testing a hard disk drive.

2. Related Art

Today, manufacturers of systems test various components of the systems (during the manufacturing process) in an attempt to ensure that the components function properly. For example, manufacturers of computer systems have tested hard disk drives (HDDs) of computer systems during a dedicated HDD testing period in the manufacturing process. Due to economic considerations, manufacturers of computer systems have attempted to reduce computer system test time, while at the same time ensuring that a computer system is adequately tested to maintain a relatively high quality product. For example, computer system manufacturers have employed various algorithms to reduce test time of an HDD of a computer system, while maintaining a relatively high confidence level in associated test results. However, as HDD capacity has continued to increase, a test time associated with testing HDDs has increased to a level that is unacceptable to many manufacturers that incorporate HDDs within their products, even when algorithms are employed to reduce the HDD test time.

Self-monitoring analysis and reporting technology (SMART), which is described in T13/1532D Volume 1, has been employed in conjunction with HDDs for prediction of HDD degradation and/or determination of HDD faults. In HDDs that implement SMART, individual SMART commands are identified by a value written to a feature register implemented with an HDD. For example, when a value of “D4h” is written to a SMART feature register, a SMART execute off-line immediate command may be executed and, in this case, an HDD may initiate an optional set of activities that collect SMART data in an off-line mode and save the collected SMART data to a non-volatile memory of the HDD or execute a self-diagnostic test routine in either a captive or off-line mode, depending on a value written to a logical block address (LBA) low register.

### SUMMARY

According to one aspect of the present disclosure, a technique for reducing testing time of a system that includes a hard disk drive (HDD) includes background testing the HDD, when an associated system is powered and the HDD is available. The technique includes receiving an interrupt test indication that indicates that the background testing of the HDD is to be interrupted and discontinuing, at a current test location, the background testing of the HDD in response to the interrupt test indication. Finally, current test results are saved in response to the interrupt test indication. In this manner, a status and progress of an HDD self-test may be preserved through a soft or hard reset, as well as a power cycle. According to various aspects of the present disclosure, an HDD may be configured to save the status and the progress of an HDD self-test in response to a pause command and continue testing (from a previous test location where the self-test last paused) in response to a resume command.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example system whose hard disk drive (HDD) may be configured according to various embodiments of the present disclosure.

FIG. 2 is a flowchart of an example background testing process for the HDD of FIG. 1, according to one embodiment of the present disclosure.

FIG. 3 is a flowchart of an example status inquiry process for the HDD of FIG. 1, according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium would include the following: a portable computer diskette, a hard disk, a random access memory (RAM), a read-only memory (ROM), an erasable programmable read-only memory (EPROM) or Flash memory, a portable compact disc read-only memory (CD-ROM), an optical storage device, or a magnetic storage device. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable storage medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single processor, on multiple processors that may be remote from each other, or as a stand-alone software package. When multiple processors are employed, one processor may be connected to another processor through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. As used herein, the term “coupled” includes both a direct electrical connection between blocks or components and an indirect electrical connection between blocks or components achieved using intervening blocks or components.

According to various aspects of the present disclosure, a number of different commands or subcommands (e.g., a start command, a pause command, a resume command, a stop command, and a status command) may be employed to facilitate a reduction in total test time of a system (e.g., a computer system, a digital video recorder, a digital audio player, a personal digital assistant, a digital camera, a video game console, or a mobile telephone) that includes a hard disk drive (HDD). According to various embodiments of the present disclosure, an HDD is tested in the background when an associated system is powered for another purpose (other than testing of the HDD) and the HDD is available (i.e., the HDD is not being utilized for another purpose). In a typical case, a start command is issued to begin self-test of an HDD located within a system. In at least one embodiment, when an HDD receives a start command any previously saved status is reset.

When a pause command is received by an HDD, all information that is considered necessary to continue testing from a pause point is saved, e.g., to a non-volatile portion of the HDD (in the event that a resume command is received at a later point in time). In at least one embodiment, current test (e.g., pass/fail) results are saved to a non-volatile portion of the HDD in response to the pause command. When a resume command is received by the HDD, testing is resumed from the pause point using the saved information. When a stop command is received by the HDD, a self-test of the HDD is terminated and the results are saved to a non-volatile area of the HDD. When a status command is received by the HDD, the saved test results are returned. An indication of whether returned results are complete or partial may also be returned. The various commands described above may be issued in response to user input to a test routine that is executing on the system or a power event (e.g., a power-up event or a power-down event as appropriate) for the system. Alternatively, when the HDD is in an appropriate test mode (e.g., a test mode entered into in response to an associated SMART command), the HDD may be configured to automatically perform a task or tasks that correspond to one of the commands based on a power condition of an associated system and whether the HDD is available (e.g., not being used to test another component (e.g., a video card, a memory subsystem, or an optical device) of the system).

According to various aspects of the present disclosure, a technique for reducing testing time of a system that includes a hard disk drive (HDD) includes background testing the HDD, when an associated system is powered and the HDD is available. The technique includes receiving an interrupt test indication that indicates that the background testing of the HDD is to be interrupted and discontinuing, at a current test location, the background testing of the HDD in response to the interrupt test indication. Finally, current test results are saved in response to the interrupt test indication. In this manner, test results provided by background testing may be preserved across power cycles, as well as hard/soft resets. When testing of the HDD is resumed at a later point in time, background testing begins at a test interruption point.

According to another aspect of the present disclosure, a hard disk drive (HDD) includes a platter for storing information, a read/write head positioned to access the information stored on the platter, a memory subsystem, and a processor coupled to the memory subsystem and the read/write head. The memory subsystem stores code that (when executed by the processor) causes the processor to background test the HDD when an associated system is powered and the HDD is available. The background test includes reading the stored information on the platter. The code (when executed by the processor) also allows the processor to receive an interrupt test indication, which indicates that the background test of the HDD is to be interrupted, and discontinue (at a current test location) the background test of the HDD in response to the interrupt test indication. Current test results associated with the background test are then saved in response to the interrupt test indication.

According to another embodiment of the present disclosure, a system includes a memory subsystem, a processor coupled to the memory subsystem, and a hard disk drive (HDD) coupled to the processor. The HDD is configured to initiate a background test of the HDD when the system is powered and the HDD is available. The HDD is further configured to receive an interrupt test indication that indicates that the background test of the HDD is to be interrupted and discontinue (at a current test location) the background test of the HDD in response to the interrupt test indication. Current test results associated with the background test are then saved in response to the interrupt test indication.

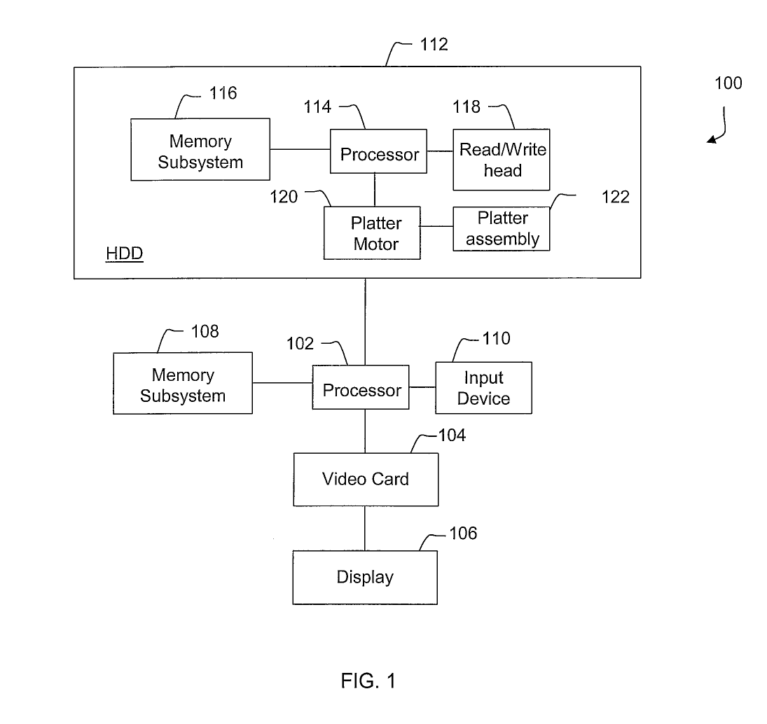

With reference to FIG. 1, an example system 100 is illustrated that includes a processor 102 (including one or more central processing units (CPUs)) that is coupled to a memory subsystem 108 (which includes an application appropriate amount of volatile and non-volatile memory), an input device 110 (e.g., a keyboard and a mouse), a video card 104 and a hard disk drive (HDD) 112. The video card 104 is coupled to a display 106 (e.g., a cathode ray tube (CRT) or a liquid crystal display (LCD)). The processor 102 may be, for example, coupled to the HDD 112 via an advanced technology attachment (ATA) interface (not shown). The HDD 112 includes a processor 114 (which may take the form of a microcontroller) that is coupled to a memory subsystem 116, a platter motor 120, and a read/write head 118. The processor 114 controls a speed of the platter motor 120 and a position of the head 118 to read/write information from/to platter assembly 122, which includes one or more platters each of which have at least one surface coated with a magnetic material. According to various aspects of the present disclosure, the processor 114 executes a test routine that may be stored in non-volatile memory within the memory subsystem 116 or on one or more platters within the platter assembly 122. When the system 100 takes the form of a computer system, the computer system may be, for example, a laptop computer system, a notebook computer system, or a desktop computer system.

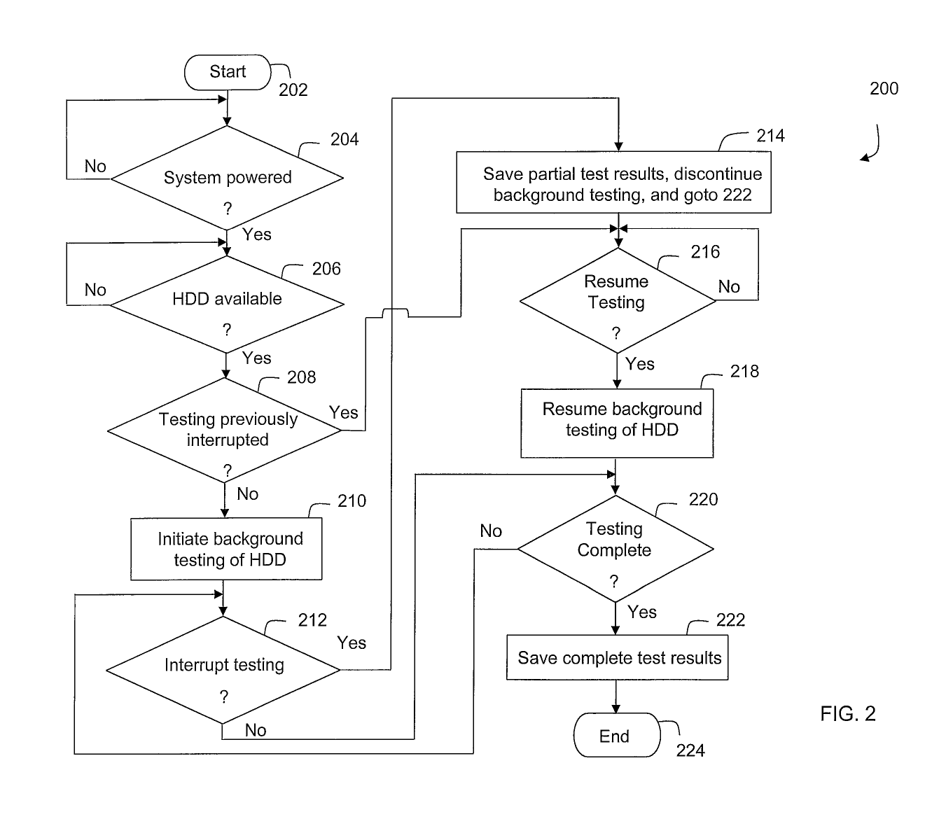

Moving to FIG. 2, an example background testing process 200 for testing the HDD 112 is illustrated. The process 200 may be externally initiated by a test (diagnostic) routine executing on the processor 102 or may be internally initiated by the processor 114 based on a triggering condition (e.g., a power-up or power-down event of the system 100). In block 202, the process 200 is initiated at which point control transfers to decision block 204. In block 204, the processor 114 determines whether the system 100 is powered. Whether the system 100 is powered may be determined from a message received by the HDD 112 or based on the fact that the HDD 112 is powered. In the event that the system 100 is powered, control transfers to decision block 206. Assuming that the HDD 112 is receiving power but the system 100 is not receiving power, control loops on block 204. In block 206, the processor 114 determines whether the HDD 112 is available for background testing. If the HDD 112 is not available for background testing, control loops on block 206.

When the HDD 112 is available for background testing, control transfers to decision block 208. In block 208, the processor 114 determines whether background testing was previously interrupted. If background testing of the HDD was previously interrupted, control transfers from block 208 to decision block 216. If background testing of the HDD was not previously interrupted, control transfers from block 208 to block 210, where background testing of the HDD is initiated. Next, in decision block 212, the processor 114 determines whether testing should be interrupted (i.e., whether a test interrupt indication has been received). Testing may be interrupted, for example, based on a message that indicates that a power-down event is imminent, a received pause command, or a received stop command. Moreover, testing may be interrupted by a host access (read/write) of the HDD 112 by the processor 102. When a test interrupt indication is received, control transfers from block 212 to block 214. When a test interrupt indication is not received, control transfers from block 212 to decision block 218.

In block 214, the processor 114 discontinues background testing, saves partial test results to a non-volatile portion of the memory subsystem 116 or to a desired location or locations on the platter assembly 122 and jumps to block 224 where the process 200 terminates. It should be appreciated that the processor 114 may be configured to periodically log test results in the event system power goes down without prior notice. Upon later re-entry into the process 200, the processor 114 (in block 208,) transfers control to decision block 216, where the processor 114 determines whether testing may resume (e.g., whether a resume command has been received or a power-up event associated with the system 100 has occurred and the HDD is still available). The processor 114 loops on block 216 until a resume test indication is received. When a resume test indication is received, control transfers from block 216 to block 218, where background testing of the HDD 112 is resumed. Next, in decision block 220, the processor 114 determines whether testing is complete. If testing is not complete in block 220, control transfers to block 212. If testing is complete in block 220, control transfers to block 222 where complete test results are saved to, for example, the memory subsystem 116, or a desired location on the platter 122. Following block 222, control transfers to block 224 where the process 200 terminates.

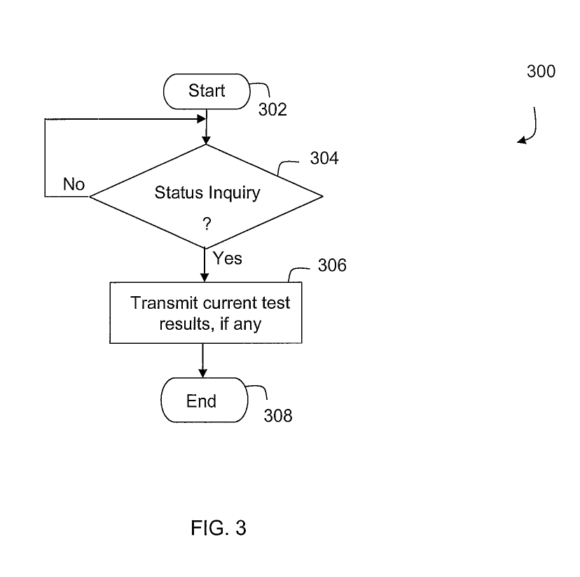

With reference to FIG. 3, a status inquiry process 300 that executes on the processor 114 of the HDD 112 is illustrated. The process 300 is initiated in block 302, at which point control transfers to decision block 304. Control loops on block 304 until a status inquiry (e.g., a status command) is received by the processor 114. When a status inquiry is received by the processor 114, control transfers to block 306, where current test results, if any, are transmitted to the processor 102. The processor 102 may then visually provide the results on the display 106 for review by a user of the system 100. Following block 306, the process 300 terminates in block 308. Accordingly, techniques have been disclosed herein that readily facilitate background testing of an HDD of a system while essentially driving dedicated HDD testing time to zero.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. For example, the present techniques can be implemented in any kind of system that includes a hard disk drive. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method, comprising:
background testing a hard disk drive when an associated system is powered and the hard disk drive is available;
receiving an interrupt test indication that indicates that the background testing of the hard disk drive is to be interrupted;
discontinuing, at a current test location, the background testing of the hard disk drive in response to the interrupt test indication; and
saving current test results in response to the interrupt test indication.

2. The method of claim 1, further comprising:
receiving a resume test indication at the hard disk drive; and
resuming, at the current test location, the background testing of the hard disk drive in response to the resume test indication.

3. The method of claim 1, wherein the resume test indication corresponds to a power-up event of the associated system or a resume command.

4. The method of claim 1, wherein the interrupt test indication corresponds to a power-down event of the associated system, a stop command, or a pause command.

5. The method of claim 1, wherein the saving current test results in response to the interrupt test indication further comprises:
saving the current test results in response to the interrupt test indication in a non-volatile area of the hard disk drive.

6. The method of claim 1, wherein the background testing a hard disk drive when an associated system is powered and the hard disk drive is available further comprises:
initiating, responsive to a start command, the background testing of the hard disk drive when the associated system is powered and the hard disk drive is available.

7. The method of claim 6, further comprising:
resetting, in response to the start command, a status that is saved in a non-volatile area on the hard disk drive.

8. The method of claim 1, further comprising:
receiving, at the hard disk drive, a status inquiry; and
transmitting, in response to the status inquiry, the current test results for the hard disk drive.

9. The method of claim 8, further comprising:
transmitting, in response to the status inquiry, an indication of whether the background testing of the hard disk drive is complete.

10. The method of claim 1, wherein the associated system is a computer system, a digital video recorder, a digital audio player, a personal digital assistant, a digital camera, a video game console, or a mobile telephone.

11. A hard disk drive, comprising:
a platter for storing information;
a read/write head positioned to access the information stored on the platter;
a memory subsystem; and
a processor coupled to the memory subsystem and the read/write head, wherein the memory subsystem stores code that when executed by the processor causes the processor to:
background test the hard disk drive when an associated system is powered and the hard disk drive is available, wherein the background test comprises reading the stored information on the platter;
receive an interrupt test indication that indicates that the background test of the hard disk drive is to be interrupted;
discontinue, at a current test location, the background test of the hard disk drive in response to the interrupt test indication; and
save current test results associated with the background test in response to the interrupt test indication.

12. The hard disk drive of claim 11, wherein the memory subsystem stores additional code that when executed by the processor causes the processor to:
receive a resume test indication at the hard disk drive; and
resume, at the current test location, the background test of the hard disk drive in response to the resume test indication.

13. The hard disk drive of claim 11, wherein the resume test indication corresponds to a power-up event of the associated system or a resume command and the interrupt test indication corresponds to a power-down event of the associated system, a stop command, or a pause command.

14. The hard disk drive of claim 11, wherein the current test results are saved in a non-volatile area of the hard disk drive.

15. The hard disk drive of claim 11, wherein the memory subsystem stores additional code that when executed by the processor causes the processor to:
reset, in response to a start command, a status that is saved in a non-volatile area on the hard disk drive.

16. The hard disk drive of claim 11, wherein the memory subsystem stores additional code that when executed by the processor causes the processor to:
receive a status inquiry; and
transmit, in response to the status inquiry, the current test results for the hard disk drive, wherein the current test results comprise an indication of whether the background test of the hard disk drive is complete.

17. A system, comprising:
a memory subsystem; and
a processor coupled to the memory subsystem; and
a hard disk drive coupled to the processor, wherein the hard disk drive is configured to:
initiate a background test of the hard disk drive when the system is powered and the hard disk drive is available;
receive an interrupt test indication that indicates that the background test of the hard disk drive is to be interrupted;
discontinue, at a current test location, the background test of the hard disk drive in response to the interrupt test indication; and
save current test results associated with the background test in response to the interrupt test indication.

18. The system of claim 17, wherein the hard disk drive is further configured to:
receive a resume test indication; and
resume, at the current test location, the background test of the hard disk drive in response to the resume test indication.

19. The system of claim 18, wherein the resume test indication corresponds to a power-up event of the associated system or a resume command and the interrupt test indication corresponds to a power-down event of the associated system, a stop command, or a pause command.

20. The system of claim 17, wherein the hard disk drive is further configured to:
receive a status inquiry; and
transmit, in response to the status inquiry, the current test results for the hard disk drive and an indication of whether the background test of the hard disk drive is complete, wherein the system is a computer system, a digital video recorder, a digital audio player, a personal digital assistant, a digital camera, a video game console, or a mobile telephone.
